(19) United States
(12) Patent Application Publication
(10) Pub. No.: US 2025/0365214 A1
(43) Pub. Date: Nov. 27, 2025

(54) SYSTEMS AND METHODS FOR PREDICTING QUALITY OF EXPERIENCE OF USER EQUIPMENT USING AN ARTIFICIAL INTELLIGENCE MODEL

(71) Applicant: ZTE CORPORATION, Shenzhen (CN)

(72) Inventors: Man ZHANG, Shenzhen (CN); Yin GAO, Shenzhen (CN); Dapeng LI, Shenzhen (CN); Jiajun CHEN, Shenzhen (CN); Yansheng LIU, Shenzhen (CN); Zhuang LIU, Shenzhen (CN)

(73) Assignee: ZTE CORPORATION, Shenzhen (CN)

(21) Appl. No.: 19/288,387

(22) Filed: Aug. 1, 2025

Related U.S. Application Data
(63) Continuation of application No. PCT/CN2023/105263, filed on Jun. 30, 2023.

(51) Int. Cl. H04L 41/16; H04L 41/5067; H04W 24/08

(52) U.S. Cl. CPC H04L 41/16; H04L 41/5067; H04W 24/08

(57) ABSTRACT

Presented are systems and methods for predicting quality of experience of user equipment (UEs) using an artificial intelligence (AI) model. A first network node of a radio access network (RAN) may receive first assistance information for use with a first quality of experience (QoE) information to perform a first function of a neural network model from a second network node of the RAN. The first network node of the RAN may perform the first function using the first QoE information and the first assistance information.

### CROSS-REFERENCE TO RELATED APPLICATION

This application claims the benefit of priority under 35 U.S.C. § 120 as a continuation of International Patent Application No. PCT/CN2023/105263, filed on Jun. 30, 2023, the disclosure of which is incorporated herein by reference in its entirety.

### TECHNICAL FIELD

The disclosure relates generally to wireless communications, including but not limited to systems and methods for predicting quality of experience (QoE) of user equipment (UEs) using an artificial intelligence (AI) model.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A first network node (e.g., a gNB, or a distributed unit (DU), or a centralized unit (CU)) of a radio access network (RAN) may receive first assistance information for use with a first quality of experience (QoE) information (e.g., from one or more UEs) to perform a first function (e.g., model inference or model training, or other model process/function/step) of a neural network model, from a second network node (e.g., a gNB, or a distributed unit (DU), or a centralized unit (CU)) of the RAN. The first network node of the RAN may perform the first function using the first QoE information and the first assistance information. Input information collected from a neighboring gNB for an artificial intelligence (AI) function may have impact on an Xn application protocol (XnAP).

In some embodiments, the first network node may receive first quality of experience (QoE) information obtained from measurement at a wireless communication device (e.g., a user equipment (UE)). The first network node may receive second QoE information obtained from measurement (e.g., monitoring, detection) at the wireless communication device and/or another wireless communication device, for use to perform a second function of the neural network model (e.g., model training or model inference, or other model/AI process/function/step). The input QoE information for the AI function can be collected from the UE side, which can protect a potential impact of Uu interface of QoE measurement. The first QoE information or the second QoE information may comprise an indication of at least one of: a QoE report container, at least one protocol data unit (PDU) session identifier (ID); at least one QoS flow ID; at least one data radio bearer (DRB) ID; a slice list; or QoE measurement results visible to the RAN. A list of information which can be included in the QoE information for the use of AI function. Currently, QoE measurement information are not used for AI function.

In some embodiments, the first network node may receive first user equipment (UE) assistance information provided by the wireless communication device or another wireless communication device, for use to perform a second function (e.g., model inference or model training, or other model/AI process/function/step) of the neural network model. The first network node may receive second UE assistance information provided by the wireless communication device, for use to perform the first function of the neural network model. Input information may be collected from UE side as assistance information for the use in AI model training or inference, apart from the QoE information, and may include information that cover impacts to Uu. The first UE assistance information or the second UE assistance information may comprise an indication of at least one of: a service type, an application, slice information, radio bearer information, cell information, beam information, binding information or group identifier (ID), UE location information, UE history information, radio link quality related information, UE measurements related to reference signal received power (RSRP), reference signal received quality (RSRQ), or signal to interference and noise ratio (SINR) of a serving cell and at least one neighboring cell, minimization of drive (MDT) measurements, or UE performance information. A list of information can be included in the UE assistance for the use of AI function. Currently, there is no assistance information collected from UE(s) for the use of predicting the QoE of UEs.

In some embodiments, the first network node or a third network node (e.g., a core network (CN) or an operations, administration and maintenance (OAM)) may send a message to the second network node to request for second assistance information for use to perform a second function (e.g., model training) of the neural network model. The message may include at least one of: an indication of which information is requested from the second network node to the first network node; a request to the second network node to provide feedback on the neural network model; or a request to the second network node to provide collected data for evaluating performance of a trained version of the neural network model. The collected data may include the following items: a UE identifier, the QoE measurement results collected at the NG RAN node 2, RAN visible QoE results collected at the NG-RAN node 2, or the mobility information of the UEs. The first or third network node from the second network node may receive the second assistance information. The model training module can be deployed in an OAM or a core network (CN). For the case of core network, there can be a NG application protocol (NGAP) impact (e.g., when the CN requests the assistance information from gNB, the gNB may report the assistance information to the CN).

In some embodiments, the first assistance information or the second assistance information may comprise an indication of at least one of: at least one user equipment (UE) identifier (ID) of a UE associated with the second network node, binding information or a group ID of a plurality of UEs associated with the second network node, a predicted or historical trajectory of one or more of the UEs, mobility information or UE historical information (UHI) of one or more of the UEs, at least one previous QoE measurement result of one or more of the UEs, measured or predicted QoE information of one or more of the UEs (e.g., in the case that the gNB2 also has the function of model inference), transmission delay, a cell list, or resource status. The first assistance information or the second assistance information can be a list of items for the assistance information between network nodes, specifically for the case that model training is deployed in the OAM or CN.

In some embodiments, the first network node may send a request message to the second network node to request for the first assistance information. The request message may comprise at least one of: an indication of which information is requested from the second network node to the first network node; a request to the second network node to provide feedback on the neural network model; or a request to the second network node to provide collected data for evaluating performance of a trained version of the neural network model.

In some embodiments, the first network node may send, to at least one other network node (e.g., a neighboring gNB), information predicted or inferred according to the second function (e.g., model inference) that includes at least one of: at least one identifier of at least one user equipment (UE) that has provided measurement results or that has not provided any measurement results, QoE information predicted for the at least one UE, trajectory information predicted for the at least one UE, a predicted or updated grouping of the at least one UE, a correlation coefficient that is indicative of a correlation between one UE and another UE, time information for validity time, an action to be taken, mobility information or UE historical information (UHI) of the at least one UE, at least one previous QoE measurement result of one or more of the at least one UE, modified QoE measurement configuration visible to the RAN, updated group information of the at least one UE, suggested or predicted QoE configuration that is visible to the RAN, or an indication to deactivate or pause reporting of QoE configuration that is visible to the RAN, over a F1AP interface. The output of the model inference module can be transferred to the neighbouring node as a reference for further actions. In such case, there can be XnAP impacts.

In some embodiments, the first function may comprise model inference using a trained version of the neural network model. The second function may comprise model training of the neural network model.

In some embodiments, the first network node may comprise: a first base station, a central unit (CU) of a base station, or a distributed unit (DU) of the base station. The second network node may comprise: a second base station, the DU of the base station, or the CU of the base station. The third network node may comprise: a node of the core network (CN), or an operations, administration and maintenance (OAM) node.

In some embodiments, the first network node or the second network node may receive a QoE configuration from an operations, administration and maintenance (OAM) node or an access and mobility management function. The first network node or the second network node may send the QoE configuration to the wireless communication device. The QoE configuration may include an indication of at least one of: an indicator to use of the first function or a second function of the neural network model, or binding information. The binding information may comprise at least one of: group information of a plurality of user equipment (UE), service type of the plurality of UE, application or application type of the plurality of UE, a protocol data unit (PDU) session identifier (ID) of the plurality of UE, a quality of service (QOS) flow ID of the plurality of UE, radio bearer information of the plurality of UE, location information of the plurality of UE, or QoE user consent of plurality of UE.

In some embodiments, the first network node to the second network node may send a request signaling comprising at least one of: a flag which is used to request the second network node to provide feedback for neural network model inference, an indication of which information is requested from the second network node to the first network node, or a flag which is used to request the second network node to provide real data collected, for the first network node to evaluate feedback for the neural network model inference. Feedback can be an important function in AI, which can allow the node which performs model inference to evaluate the performance of the AI model.

In some embodiments, the first network node may receive feedback from the second network node. The feedback can be calculated according to predicted information provided by the first network node and real data collected at the second network node. The feedback may include an indication of at least one of: accuracy of neural network model inference, confidence of a prediction of neural network model (e.g., neural network model inference), relative to real measured or collected data, a generalized value to evaluate performance of the neural network model inference, or correlation of QoE between at least two user equipment (UE).

In some embodiments, the first network node may receive data collected by the second network node from the second network node. The data received from the second network node may cover impact on/of XnAP for the procedure of feedback.

In some embodiments, a second network node (e.g., a gNB, or a distributed unit (DU), or a centralized unit (CU)) of radio access network (RAN) may send first assistance information for use with first quality of experience (QoE) information to perform a first function (e.g., model inference) of a neural network model to a first network node (e.g., a gNB, or a distributed unit (DU), or a centralized unit (CU)) of the RAN. The first QoE information can be obtained from measurement at a wireless communication device (e.g., a user equipment (UE)), and can be received by the first network node.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example functional framework for radio access network (RAN) incorporating artificial intelligence, in accordance with some embodiments of the present disclosure;

FIG. 4 illustrates a sequence diagram for predicting quality of experience of user equipment (UEs) using an artificial intelligence (AI) model, in accordance with some embodiments of the present disclosure;

FIG. 5 illustrates a sequence diagram for predicting quality of experience of user equipment (UEs) using an artificial intelligence (AI) model, in accordance with some embodiments of the present disclosure;

FIG. 6 illustrates a sequence diagram for predicting quality of experience of user equipment (UEs) using an artificial intelligence (AI) model, in accordance with some embodiments of the present disclosure;

FIG. 7 illustrates a sequence diagram for predicting quality of experience of user equipment (UEs) using an artificial intelligence (AI) model, in accordance with some embodiments of the present disclosure;

FIG. 8 illustrates a sequence diagram for predicting quality of experience of user equipments (UEs) using an artificial intelligence (AI) model, in accordance with some embodiments of the present disclosure;

FIG. 9 illustrates a sequence diagram for predicting quality of experience of user equipments (UEs) using an artificial intelligence (AI) model, in accordance with some embodiments of the present disclosure; and

FIG. 10 illustrates a flow diagram for predicting quality of experience of user equipments (UEs) using an artificial intelligence (AI) model, in accordance with an embodiment of the present disclosure.

### DETAILED DESCRIPTION

### 1. Mobile Communication Technology and Environment

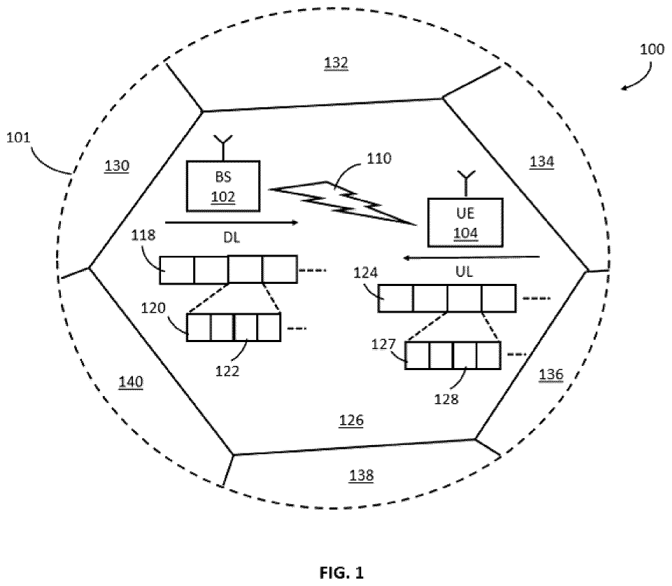

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

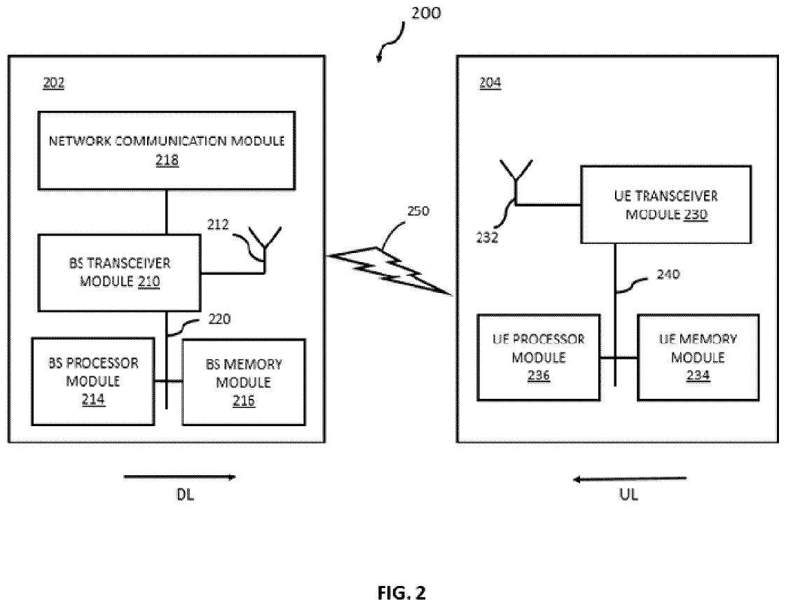

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication network 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Predicting Quality of Experience (QoE) of User Equipment (UEs) using an Artificial Intelligence (AI) Model

An artificial intelligence (AI) function can be used for data prediction based on collected real data and training/inference by a model. However, an artificial intelligence (AI)/machine learning (ML) training/inference for quality of experience (QoE) has not been supported. The present disclosure utilize an AL/ML/model function, based on collected QoE results of at least one UE, to predict the future QoE results of UEs (e.g., may include the at least one UE and the other UEs).

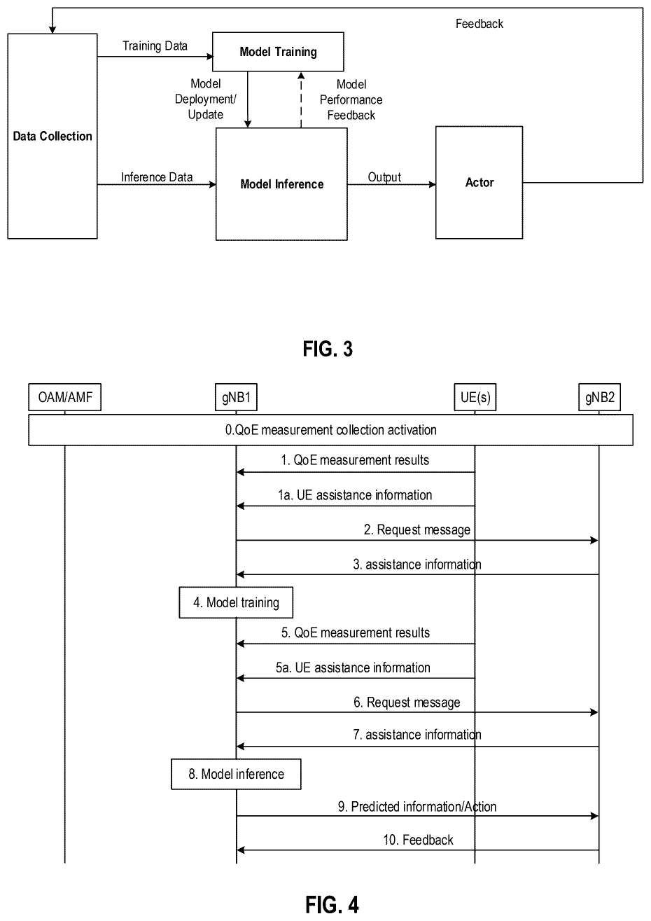

FIG. 3 illustrates an example functional framework for radio access network (RAN) intelligence, in accordance with some embodiments of the present disclosure. The AI function can be deployed in the RAN node for RAN intelligence.

Data collection: a function that may provide input data to model training and inference functions.

Model training: a function that may perform AI/ML model training, validation, and testing which may generate model performance metrics as part of the model testing procedure.

Model inference: a function that may provide AI/ML model inference output (e.g., predictions or decisions).

QoE: A QoE measurement collection (QMC) function can be supported. A new radio (NR) QMC function can be activated by an OAM via a separate QMC framework. For signaling-based QoE, the QMC configuration for a specific UE can be sent from the OAM to a core network (CN), and then the CN may send the QMC configuration to a RAN node via a UE-associated signaling. For management-based QoE, the OAM may send the QMC configuration to the RAN node, and the RAN may select UEs which satisfies the condition for QoE measurement and may send the configuration to the UEs.

For the QoE reporting in standalone architecture, a UE APP/application layer may collect QoE metrics and may send the collected data to UE access stratum (AS) layer via an AT command. The UE AS layer may send the QoE report to the RAN node, after which the RAN node may transfer the received QoE reports to a measurement collection entity (MCE). The MCE can be an entity which collects QoE measurement reports and makes analysis for optimization.

A RAN visible QoE measurement collection can be configured by the gNB, which can be configured when there is an ongoing QoE measurement in the application layer. The RAN visible QoE measurement results can be sent to the gNB as an explicit information element (IE) which is readable to the gNB. A buffer level and playout delay for DASH streaming and VR services as the RAN visible QoE metrics can be supported. Aside from the RAN visible QoE metrics, the PDU session ID(s) can be sent to the RAN node along with the RAN visible QoE measurement results.

In a RAN overload situation, the RAN node may send a pause indication to a UE, to notify the UE to pause QoE reporting. After the RAN overload situation is solved, the RAN node may send a resume indication to the UE, in order to ask the UE to resume reporting. During a mobility event (e.g., transition between RAN nodes), the pause status of the source RAN node can be passed to a target node, to indicate that the QoE reporting has been paused in the UE. The RAN visible QoE reporting may not be affected by the RAN overload, which means the RAN visible QoE reporting is not paused when the reporting of QoE report container is paused.

### Implementation Example 1: Predicting QoE Results of a Set of UEs, Model Training and Inference Both in RAN Side

FIG. 4 illustrates a sequence diagram for predicting quality of experience of user equipment (UEs) using an artificial intelligence (AI) model, in accordance with some embodiments of the present disclosure. In this implementation example, the model training and model inference module can be both deployed in the RAN node.

Step 0: A QoE measurement collection can be activated. The details are described in implementation example 3.

Step 1: The UE may send QoE measurement results to a gNB1, which can include at least one of the following items: a QoE report container, at least one protocol data unit (PDU) session identifier (ID); at least one QoS flow ID; at least one data radio bearer (DRB) ID; a slice list; or QoE measurement results visible to the RAN (e.g., buffer level, playout delay for media startup, or a generalized RAN visible QoE value). In existing implementations, QoE measurement information are not used for AI function.

Step 1a: Aside from the QoE measurement results reported to the gNB, the UEs can also report some other information which can assist the RAN node for AI model training/inference. The assistance information from UE may include at least one of the following items: a service type, an application, slice information, radio bearer information, cell information, beam information, binding information or group identifier (ID) (e.g., the UEs that share the same group ID are taken as the same group), UE location information, UE history information, radio link quality related information, UE measurements related to reference signal received power (RSRP), reference signal received quality (RSRQ), or signal to interference and noise ratio (SINR) of a serving cell and at least one neighboring cell, minimization of drive (MDT) measurements, or UE performance information. A list of information can be included in the UE assistance for the use of AI function. Currently, there is no assistance information collected from UE for the use of predicting the QoE of UEs.

Step 2: The gNB1 may send a request message to the gNB2, to ask for assistance information for model training. The information in the request message may include at least one of the following items: an indication that indicates which information is requested to provide from a NG-RAN node 2 to a NG-RAN node1.

Step 3: The gNB2 may send assistance information via an XnAP, for the gNB1 to perform model training. The assistance information from other gNB(s) may include at least one of the following items: at least one user equipment (UE) identifier (ID) of a UE associated with the second network node, binding information or a group ID of a plurality of UEs associated with the second network node, a predicted or historical trajectory of one or more of the UEs, mobility information or UE historical information (UHI) of one or more of the UEs, at least one previous QoE measurement result of one or more of the UEs, measured or predicted QoE information of one or more of the UEs (e.g., buffer level, playout delay for media startup, throughput, frame rate, round-trip time, or a generalized RAN visible QoE value), transmission delay, a cell list, or resource status. The first assistance information or the second assistance information can be a list of items for the assistance information between network nodes, specifically for the case that model training is deployed in the OAM or CN. The assistance information may target for one or multiple UEs, and when it involves multiple UEs, the information can be an average, minimum or maximum among the multiple UEs.

Step 4: The gNB1 may perform a model training based on the QoE measurement results and assistance information received from the UE and other neighboring gNBs, to predict the QoE results of UEs. The UEs may include the UEs providing QoE measurement results and the other UEs without providing the QoE measurement results.

Steps 5 and 5a: The UE may send the QoE measurement results and UE assistance information to the gNB1 as in the step 1 and step 1a.

Step 6: The gNB1 may send a request message to the gNB2, to ask for assistance information for model inference. The information in the request message may include at least one of the following items: an indication of which information is requested from the NG-RAN node 2 to the NG-RAN node 1; a request to the gNB2 to provide feedback on the neural network model; or a request to the gNB2 to provide collected data for evaluating performance of a trained version of the neural network model.

Step 7: The gNB2 may send assistance information to the gNB1 for model inference, the information over an XnAP may include at least one of the following items: at least one user equipment (UE) identifier (ID) of a UE associated with the gNB2, binding information or a group ID of a plurality of UEs associated with the gNB2, a predicted or historical trajectory of one or more of the UEs, mobility information or UE historical information (UHI) of one or more of the UEs, at least one previous QoE measurement result of one or more of the UEs, or predicted QoE information of one or more of the UEs (e.g., in the case that the gNB2 also has the function of model inference).

Step 8: The gNB1 may perform a model inference, to predict the QoE or RAN visible QoE results of a group pf UEs. Aside from the QoE or RAN visible QoE results, the predicted information may also include at least one of the following items: predicted trajectories of some of the UEs, mobility information of the UEs, or updated group information of the UEs. The gNB1 may also take some action based on the results of model inference (e.g., make the decision on handover preparation, update the binding information of UEs). For the model inference, no matter whether the UE has provided the QoE measurements or other measurements for model training/inference, the QoE results of the UE can be predicted by the model inference function.

Step 9 (optional): The gNB1 may send the predicted information to the neighboring gNB(s) (e.g., gNB2) via an XnAP. The predicted information may at least include one of the following items: at least one identifier of at least one user equipment (UE) that has provided measurement results or that has not provided any measurement results, QoE information predicted for the at least one UE (e.g., buffer level, playout delay for media startup, throughput, frame rate, round-trip time, or a generalized RAN visible QoE value), trajectory information predicted for the at least one UE, a predicted or updated grouping of the at least one UE, a correlation coefficient that is indicative of a correlation between one UE and another UE, time information for validity time (e.g., start/end time, time duration), or an action to be taken based on the model inference.

Step 10: The gNB2 may send the feedback to the gNB1, which is specifically described in implementation example 3.

Implementation Example 2: Predicting QoE Results of a Set of UEs, Model Training Deployed in OAM/CN, Model Inference Deployed in RAN side

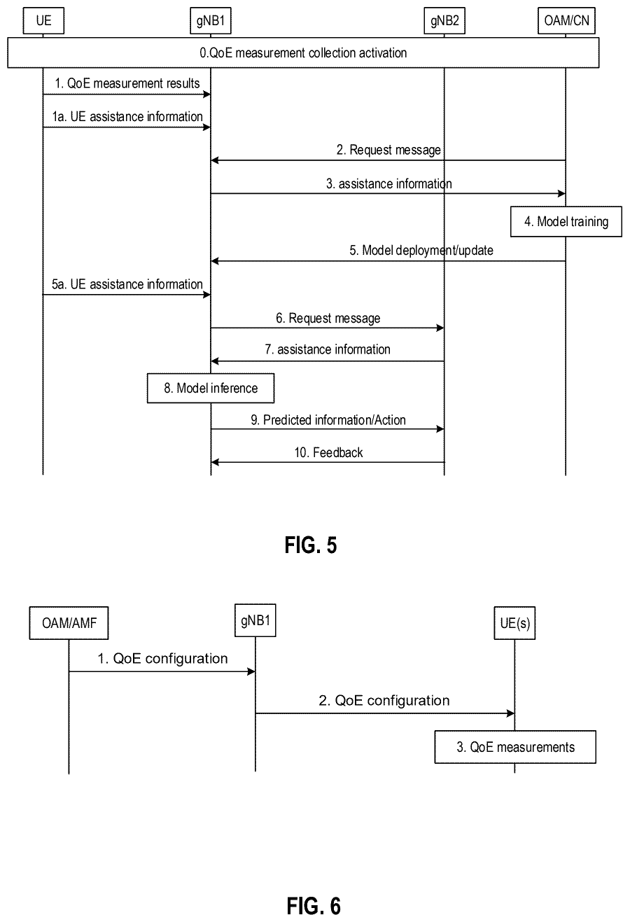

FIG. 5 illustrates a sequence diagram for predicting quality of experience of user equipment (UEs) using an artificial intelligence (AI) model, in accordance with some embodiments of the present disclosure. In this implementation example, the model training module can be deployed in an OAM or a core network (CN), while the model inference module is deployed in the RAN node.

Step 0: A QoE measurement collection can be activated. The details are described in implementation example 3.

Step 1: The UE may send QoE measurement results to a gNB1, which can include at least one of the following items: a QoE report container, at least one protocol data unit (PDU) session identifier (ID); at least one QoS flow ID; at least one data radio bearer (DRB) ID; a slice list; or QoE measurement results visible to the RAN (e.g., buffer level, playout delay for media startup, or a generalized RAN visible QoE value). Currently, QoE measurement information are not used for AI function.

Step 1a: Aside from the QoE measurement results reported to the gNB, the UEs can also report some other information which can assist the RAN node for AI model training/inference. The assistance information from UE may include at least one of the following items: a service type, an application, slice information, radio bearer information, cell information, beam information, binding information or group identifier (ID) (e.g., the UEs that share the same group ID are taken as the same group), UE location information, UE history information, radio link quality related information, UE measurements related to reference signal received power (RSRP), reference signal received quality (RSRQ), or signal to interference and noise ratio (SINR) of a serving cell and at least one neighboring cell, minimization of drive (MDT) measurements, or UE performance information. A list of information can be included in the UE assistance for the use of AI function. Currently, there is no assistance information collected from UE for the use of predicting the QoE of UEs. The UEs may include the UEs providing QoE measurement results and the other UEs without providing the QoE measurement results.

Step 2: The OAM/CN may send a request message to the gNB1, to ask for assistance information for model training. The information in the request message may include at least one of the following items: an indication that indicates which information is requested to provide from NG-RAN node 2 to NG-RAN node1, an indication to request the gNB1 for providing feedback on the AI/ML model, or an indication to request the gNB1 to provide the collected data for evaluating the trained model performance.

Step 3: The gNB1 may send assistance information to an OAM or to a CN via a NGAP, for the OAM/CN to perform model training. The assistance information from other gNB(s) may include at least one of the following items: at least one user equipment (UE) identifier (ID), binding information or a group ID of a plurality of UEs, a predicted or historical trajectory of one or more of the UEs, mobility information or UE historical information (UHI) of one or more of the UEs, at least one previous QoE measurement result of one or more of the UEs (e.g., a UE ID), or measured or predicted QoE information of one or more of the UEs (e.g., buffer level, playout delay for media startup, throughput, frame rate, round-trip time, or a generalized RAN visible QoE value). The assistance information may target for one or multiple UEs, and when it involves multiple UEs, the information can be an average, minimum or maximum among the multiple UEs.

Step 4: The OAM/CN may perform a model training based on the QoE measurement results and assistance information received from UE and other neighboring gNBs, to predict the QoE results of UEs. The UEs may include the UEs providing QoE measurement results and the other UEs without providing the QoE measurement results.

Step 5: After the model training, the OAM/CN may send the AI model to the gNB1, which can be deployed/updated in the gNB1.

Step 5a: The UE may send the QoE measurement results and assistance information to the gNB1 as in the step 1 and step 1a.

Step 6: The gNB1 may send a request message to the gNB2, to ask for assistance information for model inference.

Step 7: The gNB2 may send assistance information to the gNB1 for model inference. The information over XnAP may include at least one of the following items: UE IDs, group information of the UEs, predicted trajectory information of the UEs, mobility information/UHI of the UEs, previous QoE measurement results of the UEs, or predicted QoE of some UEs (e.g., buffer level, playout delay for media startup, throughput, frame rate, round-trip time, or a generalized RAN visible QoE value, in the case that the gNB2 also has the function of model inference).

Step 8: The gNB1 may perform a model inference, to predict the QoE or RAN visible QoE results of a group pf UEs. Aside from the QoE or RAN visible QoE results, the predicted information may include at least one of the following items: predicted trajectory information of some of the UEs, mobility information of the UEs, or updated group information of the UEs. The gNB1 may also take some action based on the results of model inference, (e.g., make the decision on handover preparation, update the binding information of UEs). For the model inference, no matter whether the UE has provided the QoE measurements or other measurements for model training/inference, the QoE results of the UE can be predicted by the model inference function.

Step 9 (Optional): The gNB1 may send the predicted information to the neighboring gNB(s) (e.g., gNB2) via an XnAP. The predicted information may at least include one of the following items: at least one identifier of at least one user equipment (UE) that has provided measurement results or that has not provided any measurement results, QoE information predicted for the at least one UE (e.g., buffer level, playout delay for media startup, throughput, frame rate, round-trip time, or a generalized RAN visible QoE value), trajectory information predicted for the at least one UE, a predicted or updated grouping of the at least one UE, a correlation coefficient that is indicative of a correlation between one UE and another UE, time information for validity time (e.g., start/end time, time duration), or an action to be taken based on the model inference.

Step 10: The gNB2 may send the feedback to the gNB1, which is specifically described in implementation example 4.

### Implementation Example 3: QoE Measurement Configuration for AI/ML Data Collection

FIG. 6 illustrates a sequence diagram for predicting quality of experience of user equipment (UEs) using an artificial intelligence (AI) model, in accordance with some embodiments of the present disclosure.

Step 1: An OAM/AMF may send a QoE measurement configuration to a gNB1. For management-based QoE, the configuration can be sent form the OAM to the gNB. For signaling-based QoE, the configuration can be sent from the OAM via an access and mobility management function (AMF) to the gNB). There can be assistance information sent together with the QoE configuration to the RAN node, for the QoE measurement collection and AI function, which may include at least one of the following items: an indicator to use of the first function or a second function of the neural network model, or binding information. The binding information may comprise at least one of: group information of a plurality of user equipment (UE) (e.g., which can be the ID that identifies a group of UEs that may have correlated quality of experience), service type of the plurality of UE (e.g., the UEs running the same or similar service type can be marked as a group), application or application type of the plurality of UE (e.g., the UEs running the same or similar application can be marked as a group), a protocol data unit (PDU) session identifier (ID) of the plurality of UE, a quality of service (QOS) flow ID of the plurality of UE, radio bearer information of the plurality of UE (e.g., the UEs that using the same radio bearer can be marked as a group), location information of the plurality of UE (e.g., the UEs sharing similar location information can be marked as a group), or QoE user consent of plurality of UE.

Step 2: The gNB1 may send a QoE measurement configuration to the UEs to trigger the application layer measurement collection and reporting in the UEs. For management-based QoE, when the RAN node performs UE selection, the gNB1 may select the UEs that satisfy the binding information in the QoE measurement configuration for the purpose of predicting QoE of UEs. The UEs may include the UEs providing QoE measurement results and the other UEs without providing the QoE measurement results.

Step 3: The UEs may perform QoE measurement in application layer and may report to the gNB1.

### Implementation Example 4: Feedback Procedures

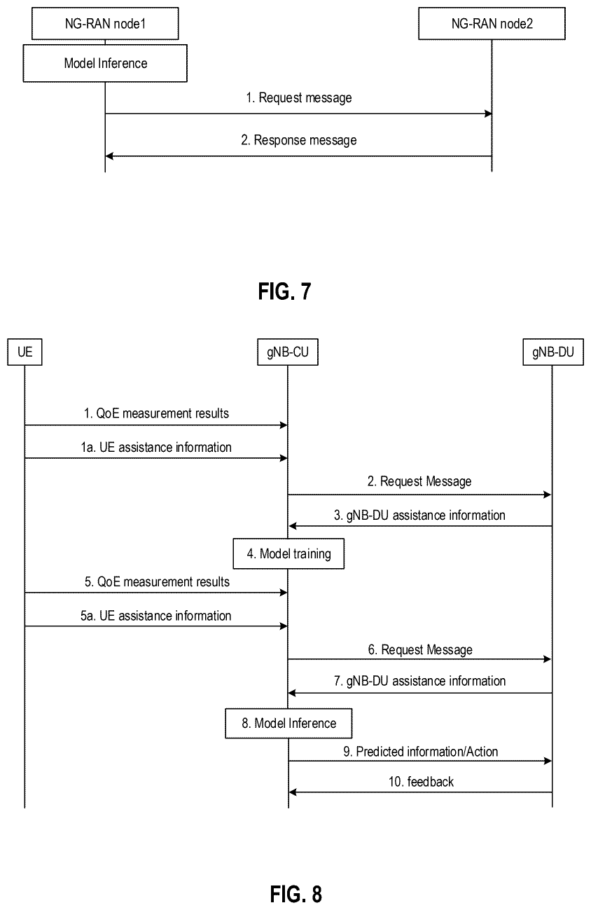

FIG. 7 illustrates a sequence diagram for predicting quality of experience of user equipments (UEs) using an artificial intelligence (AI) model, in accordance with some embodiments of the present disclosure. In some embodiments, the feedback procedure can be performed after model inference. In this implementation example, the model inference can be deployed in the NG-RAN node 1, but it does not preclude the possibility that NG-RAN node 2 has deployed its own model training and inference function.

### Option 1

Step 1: A NG-RAN node 1 may send a request message to a NG-RAN node 2. The request message may include at least one of following items: a flag which is used to request the NG-RAN node 2 to provide the feedback for model inference, or an indication that indicate which information is requested to provide from the NG-RAN node 2 to the NG-RAN node1.

Step 2: The NG-RAN node 2 may respond to the NG-RAN node 1 with calculated feedback, based on the predicted information provided by the NG-RAN node 1 and the real data collected at the NG-RAN node 2. The feedback from NG-RAN node 2 may include at least at least one of the following information: an accuracy of the model inference, a confidence of the prediction to the real measured and collected data, a generalized value to evaluate the performance of the inference model (e.g., good or bad), a correlation of QoE of different UEs.

Step 3: The NG-RAN node 1 may evaluate the AI/ML model, based on the feedback received from the NG-RAN node 2.

### Option 2

Step 1: A NG-RAN node 1 may send a request message to a NG-RAN node 2. The request message may include the following item: a flag which is used to request the NG-RAN node 2 to provide the real data collected, in order for the NG-RAN node1 to evaluate the feedback of the model inference.

Step 2: The NG-RAN node 2 may provide collected data to the NG-RAN node1. The collected data may include the following items: a UE identifier, the QoE measurement results collected at the NG RAN node 2, RAN visible QoE results collected at the NG-RAN node 2, or the mobility information of the UEs.

Step 3: The NG-RAN node 1 may calculate the feedback for evaluating and updating the model, based on the real data received from NG-RAN node 2. The feedback may include at least one of the following information: an accuracy of the model inference, a confidence of the prediction to the real measured and collected data, a generalized value to evaluate the performance of the inference model (e.g., good or bad), or a correlation of QoE of different UEs.

Implementation Example 5: CU-DU split-Model Inference Deployed in CU

FIG. 8 illustrates a sequence diagram for predicting quality of experience of user equipment (UEs) using an artificial intelligence (AI) model, in accordance with some embodiments of the present disclosure.

Step 1: UE(s) may report QoE measurement results to a gNB-CU, which may include at least one of the following items: a QoE report container, PDU session ID(s), QoS Flow ID(s), DRB ID(s), a slice list, or RAN visible QoE measurement results (e.g., buffer level, playout delay for media startup).

Step 1a: The UE(s) may also send some other assistance information to the gNB-CU in order to assist with the QoE prediction in the gNB-CU. The information may at least include one of the following items: a service type, an application, slice information, radio bearer information, cell information, beam information, binding information (e.g., group ID), UE location information, UE history information, radio link quality related information, UE measurements related to RSRP, RSRQ, SINR of serving cell and neighboring cells, or MDT measurements.

Step 2: The gNB-CU may send a request message to a gNB-DU, to request for the assistance information provided by the gNB-DU to assist with model training. The information in the request message may at least include one of the following items: information that the gNB-CU wants to achieve from the gNB-DU (e.g., the collected data to assist with model training), an indication to request the gNB-DU for providing feedback on the AI/ML model, an indication to request the gNB-DU to provide the collected data for evaluating the training model.

Step 3: The gNB-DU may send assistance information to the gNB-CU via a F1AP. The assistance information may include at least one of the following items: a transmission delay, a cell list, or resource status.

Step 4: The gNB-CU may collect information from the UEs and the gNB-DU and may perform a model training.

Steps 5, 5a: The UEs may provide the QoE measurement results and other measurements as assistance information, as in step1 and step 1a.

Step 6: The gNB-CU may send a request message to the gNB-DU, to request for the assistance information provided by the gNB-DU to assist with model inference. The information in the request message may at least include one of the following items: information that the gNB-CU wants to achieve from the gNB-DU (e.g., the collected data to assist with model inference), an indication to request the gNB-DU for providing feedback on the AI/ML model, or an indication to request the gNB-DU to provide the collected data for evaluating the training model.

Step 7: The gNB-DU may send assistance information to the gNB-CU via a F1AP. The assistance information may include at least one of the following items: a transmission delay, a cell list, or a resource usage.

Step 8: The gNB-CU may collect information from the UEs and gNB-DU and may perform model inference, to predict the QoE or RAN visible QoE results of a group pf UEs. Aside from the QoE or RAN visible QoE results, the predicted information may include at least one of the following items: predicted trajectory information of some of the UEs, mobility information/UHI of the UEs, or previous/predicted QoE measurement results of the UEs. The gNB-CU may take some action based on the results of model inference (e.g., modify the configuration of RAN visible QoE). For the model inference, no matter whether the UE has provided the QoE measurements or other measurements for model training/inference, the QoE results of the UE can be predicted by the model inference function.

Step 9: The gNB-CU may send the predicted information and action to the gNB-DU via a F1AP, to assist with the network optimization. The information transferred over F1AP may include at least one of the following items: UE ID(s), predicted QoE results of the corresponding UE(s) (e.g., buffer level, playout delay for media startup, throughput, frame rate, round-trip time, or a generalized RAN visible QoE value), predicted trajectory information of UE(s), mobility information/UHI of the UE(s), updated group information of UEs, previous QoE measurement results of the UE(s) (e.g., buffer level, playout delay for media startup, throughput, frame rate, round-trip time, or a generalized RAN visible QoE value), or a modified RAN visible QoE configuration (e.g. reporting periodicity, RAN visible QoE metrics, threshold triggers, event triggers).

Step 10: The gNB-DU may provide the feedback to the gNB-CU as requested by the gNB-CU in previous steps. The feedback message may include at least one of the following items: an accuracy of the model inference, a variance of the prediction to the real measured and collected data, a generalized value to evaluate the performance of the inference model (e.g., good or bad), or real collected data after the gNB-DU received the predicted data from the gNB-CU.

Implementation Example 6: CU-DU split-Model Inference deployed in DU

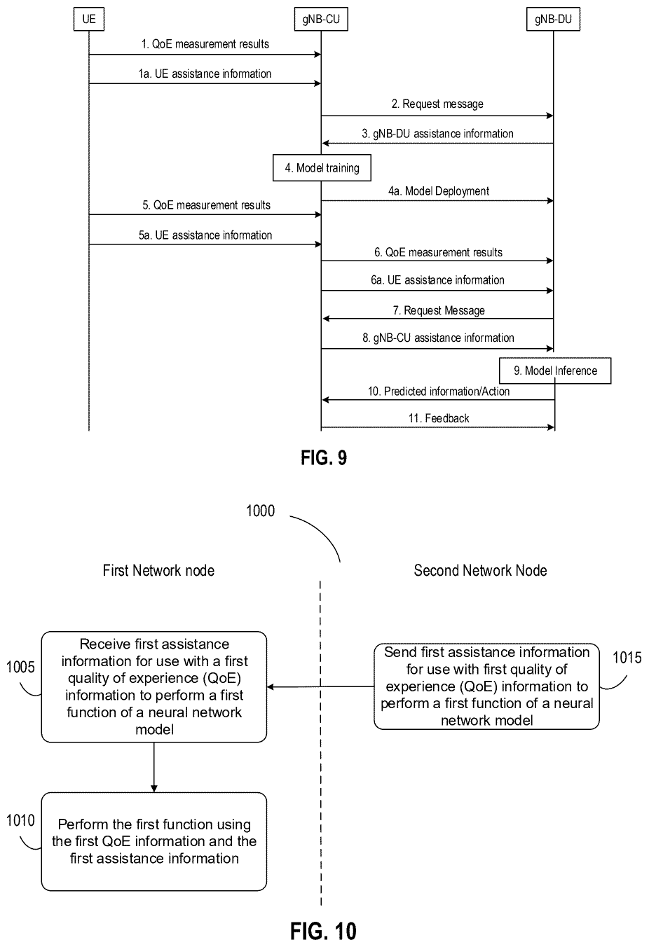

FIG. 9 illustrates a sequence diagram for predicting quality of experience of user equipment (UEs) using an artificial intelligence (AI) model, in accordance with some embodiments of the present disclosure.

Step 1: UE(s) may report QoE measurement results to a gNB-CU, which may include at least one of the following items: a QoE report container, PDU session ID(s), QoS Flow ID(s), DRB ID(s), a slice list, or RAN visible QoE measurement results (e.g., buffer level, playout delay for media startup, jitter, throughput).

Step 1a: The UE(s) may also send some other assistance information to the gNB-CU in order to assist with the QoE prediction in the gNB-CU. The information may at least include one of the following items: a service type, an application, slice information, radio bearer information, cell information, beam information, binding information (e.g., group ID), UE location information, UE history information, radio link quality related information, UE measurements related to RSRP, RSRQ, SINR of serving cell and neighboring cells, or MDT measurements.

Step 2: The gNB-CU may send a request message to the gNB-DU, to request for the assistance information provided by the gNB-DU to assist with model training. The information in the request message may at least include one of the following items: information that the gNB-CU wants to achieve from the gNB-DU (e.g., the collected data to assist with model training), an indication to request the gNB-DU for providing feedback on the AI/ML model, or an indication to request the gNB-DU to provide the collected data for evaluating the training model.

Step 3: The gNB-DU may provide assistance information to the gNB-DU via a F1AP. The assistance information may include at least one of the following items: a transmission delay, a cell list, or a resource usage.

Step 4: The gNB-CU may collect information from the UEs and the gNB-DU, and may perform model training.

Step 4a: After the model training, the gNB-CU may send the AI model to the gNB-DU, which can be deployed/updated in the gNB-DU/gNB1.

Steps 5, 5a: The UEs may provide the QoE measurement results and other measurements as assistance information, as in step1 and step 1a.

Step 6: The gNB-CU may transfer the QoE measurement results to the gNB-DU via a F1AP message.

Step 6a: The gNB-CU may transfer the UE assistance information received in step 5a to the gNB-DU via a F1AP.

Step 7: The gNB-DU may send a request message to the gNB-CU, to request for the assistance information provided by the gNB-CU to assist with model inference. The information in the request message may at least include one of the following items: information that the gNB-DU wants to achieve from the gNB-CU (e.g., the collected data to assist with model inference), an indication to request the gNB-CU for providing feedback on the AI/ML model, or an indication to request the gNB-CU to provide the collected data for evaluating the training model.

Step 8: The gNB-CU may send assistance information to the gNB-DU via a F1AP. The assistance information may include at least one of the following items: UE IDs, group information of the UEs, predicted trajectory information of the UEs, mobility information/UHI of the UEs, previous QoE measurement results of the UEs (e.g., buffer level, playout delay for media startup, throughput, frame rate, round-trip time, or a generalized RAN visible QoE value), or predicted QoE of UEs (e.g., buffer level, playout delay for media startup, throughput, frame rate, round-trip time, or a generalized RAN visible QoE value, in the case that the gNB-CU also has the function of model inference).

Step 9: The gNB-DU may collect information from the UEs and the gNB-CU and may perform model inference, to predict the QoE or RAN visible QoE results of a group pf UEs. Aside from the QoE or RAN visible QoE results, the predicted information may include at least one of the following items: predicted trajectory informaiton of some of the UEs, mobility information/UHI of the UEs, or previous/predicted QoE measurement results of the UEs. The gNB-DU may take some action based on the results of model inference (e.g., deactivate or pause the RAN visible QoE reporting over a F1AP). For the model inference, no matter whether the UE has provided the QoE measurements or other measurements for model training/inference, the QoE results of the UE can be predicted by the model inference function.

Step 10: The gNB-DU may send the predicted information and action to the gNB-CU via a F1AP. The information transferred over a F1AP may include at least one of the following items: UE ID(s), predicted QoE results of the corresponding UE(s) (e.g., buffer level, playout delay for media startup, throughput, frame rate, round-trip time, or a generalized RAN visible QoE value), predicted trajectory information of UE(s), mobility information/UHI of the UE(s), updated group information of UEs, suggested RAN visible QoE configuration (e.g. reporting periodicity, RAN visible QoE metrics, threshold triggers, event triggers), or an indication to deactivate/pause the reporting of RAN visible QoE over a F1AP.

Step 11: In certain embodiments, the gNB-DU may provide feedback to the gNB-CU as requested by the gNB-CU in previous steps. The feedback message could include at least one of the following items: an accuracy of the model inference, a variance of the prediction to the real measured and collected data, a generalized value to evaluate the performance of the inference model (e.g., good or bad), or real collected data after gNB-DU received the predicted data from the gNB-CU.

It should be understood that one or more features from the above implementation examples are not exclusive to the specific implementation examples and/or embodiments, but can be combined in any manner (e.g., in any priority and/or order, concurrently or otherwise).

FIG. 10 illustrates a flow diagram of a method 1000 for predicting quality of experience (QoE) of user equipment (UEs) using an artificial intelligence (AI) model. The method 1000 may be implemented using any one or more of the components and devices detailed herein in conjunction with FIGS. 1-2. In overview, the method 1000 may be performed by a network node, in some embodiments. Additional, fewer, or different operations may be performed in the method 1000 depending on the embodiment. At least one aspect of the operations is directed to a system, method, apparatus, or a computer-readable medium.

A first network node (e.g., a gNB, or a distributed unit (DU), or a centralized unit (CU)) of a radio access network (RAN) may receive first assistance information for use with a first quality of experience (QoE) information to perform a first function (e.g., model inference or model training) of a neural network model (e.g., model function/step/process) from a second network node (e.g., a gNB, or a distributed unit (DU), or a centralized unit (CU)) of the RAN. The first network node of the RAN may perform the first function using the first QoE information and the first assistance information. Input information collected from a neighboring gNB for an artificial intelligence (AI) function may have impact on an Xn application protocol (XnAP).

In some embodiments, the first network node may receive first quality of experience (QoE) information obtained from measurement at a wireless communication device (e.g., a user equipment (UE)). The first network node may receive second QoE information obtained from measurement at the wireless communication device or another wireless communication device, for use to perform a second function of the neural network model (e.g., model training or model inference). The input QoE information for the AI function can be collected from the UE side, which can protect a potential impact of Uu interface of QoE measurement. The first QoE information or the second QoE information may comprise an indication of at least one of: a QoE report container, at least one protocol data unit (PDU) session identifier (ID); at least one QoS flow ID; at least one data radio bearer (DRB) ID; a slice list; or QoE measurement results visible to the RAN. A list of information which can be included in the QoE information for the use of AI function. Currently, QoE measurement information are not used for AI function.

In some embodiments, the first network node may receive first user equipment (UE) assistance information provided by the wireless communication device or another wireless communication device, for use to perform a second function (e.g., model inference or model training) of the neural network model (e.g., model function/step/process). The first network node may receive second UE assistance information provided by the wireless communication device, for use to perform the first function of the neural network model. The input information collected from UE side as assistance information for the use of AI model training or inference, aside from the QoE information, which may cover the Uu impacts. The first UE assistance information or the second UE assistance information may comprise an indication of at least one of: a service type, an application, slice information, radio bearer information, cell information, beam information, binding information or group identifier (ID), UE location information, UE history information, radio link quality related information, UE measurements related to reference signal received power (RSRP), reference signal received quality (RSRQ), or signal to interference and noise ratio (SINR) of a serving cell and at least one neighboring cell, minimization of drive (MDT) measurements, or UE performance information. A list of information can be included in the UE assistance for the use of AI function. Currently, there is no assistance information collected from UE for the use of predicting the QoE of UEs.

In some embodiments, the first network node or a third network node (e.g., a core network (CN) or an operations, administration and maintenance (OAM)) to the second network node may send a message to request for second assistance information for use to perform a second function (e.g., model training) of the neural network model. The message may include at least one of: an indication of which information is requested from the second network node to the first network node; a request to the second network node to provide feedback on the neural network model; or a request to the second network node to provide collected data for evaluating performance of a trained version of the neural network model. The collected data may include the following items: a UE identifier, the QoE measurement results collected at the NG RAN node 2, RAN visible QoE results collected at the NG-RAN node 2, or the mobility information of the UEs. The first or third network node from the second network node may receive the second assistance information. The model training module can be deployed in an OAM or a core network (CN). For the case of core network, there can be a NG application protocol (NGAP) impact (e.g., when the CN requests the assistance information from gNB, the gNB may report the assistance information to the CN).

In some embodiments, the first assistance information or the second assistance information may comprise an indication of at least one of: at least one user equipment (UE) identifier (ID) of a UE associated with the second network node, binding information or a group ID of a plurality of UEs associated with the second network node, a predicted or historical trajectory of one or more of the UEs, mobility information or UE historical information (UHI) of one or more of the UEs, at least one previous QoE measurement result of one or more of the UEs, measured or predicted QoE information of one or more of the UEs (e.g., in the case that the gNB2 also has the function of model inference), transmission delay, a cell list, or resource status. The first assistance information or the second assistance information can be a list of items for the assistance information between network nodes, specifically for the case that model training is deployed in the OAM or CN.

In some embodiments, the first network node to the second network node may send a request message to request for the first assistance information. The request message may comprise at least one of: an indication of which information is requested from the second network node to the first network node; a request to the second network node to provide feedback on the neural network model; or a request to the second network node to provide collected data for evaluating performance of a trained version of the neural network model.

In some embodiments, the first network node may send, to at least one other network node (e.g., a neighboring gNB), information predicted or inferred according to the second function (e.g., model inference) that includes at least one of: at least one identifier of at least one user equipment (UE) that has provided measurement results or that has not provided any measurement results, QoE information predicted for the at least one UE, trajectory information predicted for the at least one UE, a predicted or updated grouping of the at least one UE, a correlation coefficient that is indicative of a correlation between one UE and another UE, time information for validity time, an action to be taken, mobility information or UE historical information (UHI) of the at least one UE, at least one previous QoE measurement result of one or more of the at least one UE, modified QoE measurement configuration visible to the RAN, updated group information of the at least one UE, suggested or predicted QoE configuration that is visible to the RAN, or an indication to deactivate or pause reporting of QoE configuration that is visible to the RAN, over a F1AP interface. The output of the model inference module can be transferred to the neighboring node as a reference for further actions.

In some embodiments, the first function may comprise model inference using a trained version of the neural network model. The second function may comprise model training of the neural network model.

In some embodiments, the first network node may comprise: a first base station, a central unit (CU) of a base station, or a distributed unit (DU) of the base station. The second network node may comprise: a second base station, the DU of the base station, or the CU of the base station. The third network node may comprise: a node of the core network (CN), or an operations, administration and maintenance (OAM) node/function.

In some embodiments, the first network node or the second network node may receive a QoE configuration from an operations, administration and maintenance (OAM) node or an access and mobility management function. The first network node or the second network node may send the QoE configuration to the wireless communication device. The QoE configuration may include an indication of at least one of: an indicator to use of the first function or a second function of the neural network model, or binding information. The binding information may comprise at least one of: group information of a plurality of user equipment (UE), service type of the plurality of UE, application or application type of the plurality of UE, a protocol data unit (PDU) session identifier (ID) of the plurality of UE, a quality of service (QOS) flow ID of the plurality of UE, radio bearer information of the plurality of UE, location information of the plurality of UE, or QoE user consent of plurality of UE.

In some embodiments, the first network node to the second network node may send a request signaling comprising at least one of: a flag which is used to request the second network node to provide feedback for neural network model inference, an indication of which information is requested from the second network node to the first network node, or a flag which is used to request the second network node to provide real data collected, for the first network node to evaluate feedback for the neural network model inference. Feedback can be an important function in AI, which can allow the node which performs model inference to evaluate the performance of the AI model.

In some embodiments, the first network node may receive feedback from the second network node. The feedback can be calculated according to predicted information provided by the first network node and real data collected at the second network node. The feedback may include an indication of at least one of: accuracy of neural network model inference, confidence of a prediction of neural network model (e.g., neural network model inference), relative to real measured or collected data, a generalized value to evaluate performance of the neural network model inference, or correlation of QoE between at least two user equipment (UE).

In some embodiments, the first network node may receive data collected by the second network node from the second network node. The receiving data from the second network node may cover the XnAP impact for the procedure of feedback.

In some embodiments, a second network node (e.g., a gNB, or a distributed unit (DU), or a centralized unit (CU)) of radio access network (RAN) may send first assistance information for use with first quality of experience (QoE) information to perform a first function (e.g., model inference) of a neural network model to a first network node (e.g., a gNB, or a distributed unit (DU), or a centralized unit (CU)) of the RAN. The first QoE information can be obtained from measurement at a wireless communication device (e.g., a user equipment (UE)), and can be received by the first network node.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module”), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A method comprising:
receiving, by a first network node of a radio access network (RAN), from a second network node of the RAN, first assistance information for use with a first quality of experience (QoE) information to perform a first function of a neural network model; and
performing, by the first network node, the first function using the first QoE information and the first assistance information.

2. The method of claim 1, comprising at least one of:
receiving, by the first network node, first quality of experience (QoE) information obtained from measurement at a wireless communication device; or
receiving, by the first network node, second QoE information obtained from measurement at the wireless communication device or another wireless communication device, for use to perform a second function of the neural network model.

3. The method of claim 2, wherein the first QoE information or the second QoE information comprises an indication of at least one of:
a QoE report container,
at least one protocol data unit (PDU) session identifier (ID);
at least one QoS flow ID;
at least one data radio bearer (DRB) ID;
a slice list; or
QoE measurement results visible to the RAN.

4. The method of claim 1, comprising at least one of:
receiving, by the first network node, first user equipment (UE) assistance information provided by the wireless communication device or another wireless communication device, for use to perform a second function of the neural network model; or
receiving, by the first network node, second UE assistance information provided by the wireless communication device, for use to perform the first function of the neural network model.

5. The method of claim 4, wherein the first UE assistance information or the second UE assistance information comprises an indication of at least one of:
a service type,
an application,
slice information,
radio bearer information,
cell information,
beam information,
binding information or group identifier (ID),
UE location information,
UE history information,
radio link quality related information,
UE measurements related to reference signal received power (RSRP), reference signal received quality (RSRQ), or signal to interference and noise ratio (SINR) of a serving cell and at least one neighbouring cell,
minimization of drive (MDT) measurements, or
UE performance information.

6. The method of claim 1, comprising at least one of:
sending, by the first network node or a third network node to the second network node, a message to request for second assistance information for use to perform a second function of the neural network model, the message including at least one of:
an indication of which information is requested from the second network node to the first network node;
a request to the second network node to provide feedback on the neural network model; or
a request to the second network node to provide collected data for evaluating performance of a trained version of the neural network model; or
receiving, by the first or third network node from the second network node, the second assistance information.

7. The method of claim 6, wherein the first assistance information or the second assistance information comprises an indication of at least one of:
at least one user equipment (UE) identifier (ID) of a UE associated with the second network node,
binding information or a group ID of a plurality of UEs associated with the second network node,
a predicted or historical trajectory of one or more of the UEs,
mobility information or UE historical information (UHI) of one or more of the UEs,
at least one previous QoE measurement result of one or more of the UEs,
measured or predicted QoE information of one or more of the UEs,
transmission delay,
a cell list, or
resource status.

8. The method of claim 1, comprising:
sending, by the first network node to the second network node, a request message to request for the first assistance information, the request message comprising at least one of:
an indication of which information is requested from the second network node to the first network node;
a request to the second network node to provide feedback on the neural network model; or
a request to the second network node to provide collected data for evaluating performance of a trained version of the neural network model.

9. The method of claim 2, comprising:
sending, by the first network node to at least one other network node, information predicted or inferred according to the second function that includes at least one of:
at least one identifier of at least one user equipment (UE) that has provided
measurement results or that has not provided any measurement results,
QoE information predicted for the at least one UE,
trajectory information predicted for the at least one UE,
a predicted or updated grouping of the at least one UE,
a correlation coefficient that is indicative of a correlation between one UE and another UE,
time information for validity time,
an action to be taken,
mobility information or UE historical information (UHI) of the at least one UE,
at least one previous QoE measurement result of one or more of the at least one UE,
modified QoE measurement configuration visible to the RAN,
updated group information of the at least one UE,
suggested or predicted QoE configuration that is visible to the RAN, or
an indication to deactivate or pause reporting of QoE configuration that is visible to the RAN, over a F1AP interface.

10. The method of claim 2, wherein at least one of:
the first function comprises model inference using a trained version of the neural network model; or
the second function comprises model training of the neural network model.

11. The method of claim 1, wherein at least one of:
the first network node comprises: a first base station, a central unit (CU) of a base station, or a distributed unit (DU) of the base station;
the second network node comprises: a second base station, the DU of the base station, or the CU of the base station; or
the third network node comprises: a node of the core network (CN), or an operations, administration and maintenance (OAM) node.

12. The method of claim 1, comprising:
receiving, by the first network node or the second network node, from an operations, administration and maintenance (OAM) node or an access and mobility management function, a QoE configuration; and
sending, by the first network node or the second network node, to the wireless communication device, the QoE configuration.

13. The method of claim 12, wherein the QoE configuration includes an indication of at least one of:
an indicator to use of the first function or a second function of the neural network model, or
binding information that comprises at least one of:
group information of a plurality of user equipment (UE),
service type of the plurality of UE,
application or application type of the plurality of UE,
a protocol data unit (PDU) session identifier (ID) of the plurality of UE,
a quality of service (QOS) flow ID of the plurality of UE,
radio bearer information of the plurality of UE,
location information of the plurality of UE, or
QoE user consent of plurality of UE.

14. The method of claim 1, comprising:
sending, by the first network node to the second network node, a request signaling comprising at least one of:
a flag which is used to request the second network node to provide feedback for neural network model inference,
an indication of which information is requested from the second network node to the first network node, or
a flag which is used to request the second network node to provide real data collected, for the first network node to evaluate feedback for the neural network model inference.

15. The method of claim 1, comprising:
receiving, by the first network node from the second network node, feedback that is calculated according to predicted information provided by the first network node and real data collected at the second network node, wherein the feedback includes an indication of at least one of:
accuracy of neural network model inference,
confidence of a prediction of of neural network model, relative to real measured or collected data,
a generalized value to evaluate performance of the neural network model inference, or
correlation of QoE between at least two user equipment (UE).

16. The method of claim 1, comprising:
receiving, by the first network node from the second network node, data collected by the second network node.

17. A method comprising:
sending, by a second network node of radio access network (RAN) to a first network node of the RAN, first assistance information for use with first quality of experience (QoE) information to perform a first function of a neural network model,
wherein the first QoE information is obtained from measurement at a wireless communication device, and is received by the first network node.

18. A second network node of a radio access network (RAN), comprising:
at least one processor configured to:
send, via a transmitter to a first network node of the RAN, first assistance information for use with first quality of experience (QoE) information to perform a first function of a neural network model,
wherein the first QoE information is obtained from measurement at a wireless communication device, and is received by the first network node.

19. A first network node of a radio access network (RAN), comprising:
at least one processor configured to:
receive, via a receiver from a second network node of the RAN, first assistance information for use with a first quality of experience (QoE) information to perform a first function of a neural network model; and
perform the first function using the first QoE information and the first assistance information.

20. The first network node of claim 19, wherein the first network node is configured to at least one of:
receive, via the receiver, first quality of experience (QoE) information obtained from measurement at a wireless communication device; or
receive, via the receiver, second QoE information obtained from measurement at the wireless communication device or another wireless communication device, for use to perform a second function of the neural network model.
